(19) United States
(12) Patent Application Publication
(10) Pub. No.: US 2020/0286132 A1
(43) Pub. Date: Sep. 10, 2020

(54) SECOND-HAND VEHICLE TRANSACTION METHOD AND SERVER

(71) Applicant: LAUNCH TECH CO., LTD., Shenzhen, Guangdong (CN)

(72) Inventors: Jun LIU, Shenzhen, Guangdong (CN); Xin LIU, Shenzhen, Guangdong (CN); Zhaohui GUO, Shenzhen, Guangdong (CN); Fei LAN, Shenzhen, Guangdong (CN)

(21) Appl. No.: 16/061,333

(22) PCT Filed: May 31, 2018
(86) PCT No.: PCT/CN2018/089406

§ 371 Date: Jun. 11, 2018

(51) Int. Cl. G06Q 30/02; G06Q 10/10; G06Q 30/06; G06Q 50/18; G06Q 30/00; G06Q 20/10; H04L 29/06; G06F 21/62

(52) U.S. Cl. CPC G06Q 30/0278; G06Q 10/10; G06Q 30/0627; G06Q 50/18; G06Q 2220/123; G06Q 20/102; H04L 63/12; G06F 21/6218; G06Q 30/0185

(57) ABSTRACT

A second-hand vehicle transaction method and server, the method comprises: receiving second-hand vehicle sales information and a sales smart contract submitted by a seller client, registering which in a block chain and perform a entire network radio; receiving a second-hand vehicle transaction request submitted by a buyer client, according to which searching matched second-hand vehicle sales information, and sending the matched second-hand vehicle sales information to the buyer client; executing a target sales smart contract according to a target second-hand vehicle information selected by the buyer client; generating a second-hand vehicle sales contract according to the execution result, and registering the second-hand vehicle sales contract in the block chain after the second-hand vehicle sales contract is confirmed by the buyer client and the seller client.

### FIELD OF THE PRESENT APPLICATION

The present application pertains to the technical field of vehicles, and particularly relates to a second-hand vehicle transaction method and server.

### THE RELATED ART

In recent years, with the popularization of automobiles, transaction services of second-hand vehicle are increasing gradually. The traditional offline second-hand vehicle transaction is generally carried out by buying a vehicle offline through a service worker (e.g., an intermediary person) of a second-hand vehicle, and the second-hand vehicle condition and the sales price are evaluated by means of personal experience. When the buyer purchases the vehicle, the sales price of the second-hand vehicle is determined by the buyer and the seller in a negotiation manner.

Although online second-hand vehicle transaction includes a vehicle evaluation step, the transaction platform is an online centralization platform, and the accuracy and the fairness of data in the transaction platform cannot be guaranteed. Therefore, the evaluation on each aspect of the second-hand vehicle via the online transaction platform cannot be fair, impartial and transparent.

### SUMMARY

In view of the above, the embodiments of the present application provide a second-hand vehicle transaction method and server, so as to solve the problems in the prior art that transaction data are prone to be tampered in the transaction process and the authenticity of transaction data cannot be guaranteed.

The first aspect of the embodiments of the present application provides a second-hand vehicle transaction method comprising:

receiving second-hand vehicle sales information and a sales smart contract submitted by a seller client, wherein the sales smart contract comprises a second-hand vehicle sales price;

registering the second-hand vehicle sales information and the sales smart contract into a block chain and radioing the second-hand vehicle sales information and the sales smart contract in the entire network of the block chain;

receiving a second-hand vehicle transaction request submitted by a buyer client;

searching matched second-hand vehicle sales information according to the second-hand vehicle transaction request and sending the matched second-hand vehicle sales information to the buyer client;

performing a target sales smart contract according to target second-hand vehicle information selected by the buyer client;

generating a second-hand vehicle sales contract according to an execution result of the target sales smart contract, and registering the second-hand vehicle sales contract into the block chain after the second-hand vehicle sales contract is confirmed by the buyer client and the seller client.

Optionally, before said receiving second-hand vehicle sales information and a sales smart contract submitted by a seller client, the method further comprises:

receiving a second-hand vehicle evaluation request submitted by the seller client, wherein the second-hand vehicle evaluation request comprises a vehicle identifier and usage authorization of historical vehicle condition information;

verifying the validity of the second-hand vehicle evaluation request;

if the second-hand vehicle evaluation request is valid, calling the historical vehicle condition information corresponding to the vehicle identifier based on the usage authorization of historical vehicle condition information, and generating a vehicle condition evaluation report and a second-hand vehicle recommended sales price; and

sending the vehicle condition evaluation report and the second-hand vehicle recommended sales price to the seller client, to make a reference for the seller client when the second-hand vehicle sales information and the sales smart contract are submitted by the seller client.

Optionally, after said generating a vehicle condition evaluation report and a second-hand vehicle recommended sales price, the method further comprises:

generating a usage smart contract of the vehicle condition evaluation report, wherein the usage smart contract comprises a usage charging rule of the vehicle condition evaluation report, and an income sharing rule;

sending the usage smart contract to the seller client;

registering the vehicle condition evaluation report and the usage smart contract into the block chain and radioing the vehicle condition evaluation report and the usage smart contract after a confirmation instruction from the seller client is received.

Optionally, before said performing a target sales smart contract according to target second-hand vehicle information selected by the buyer client, the method further comprises:

receiving a target vehicle condition evaluation report review request sent by the buyer client, wherein the target vehicle condition evaluation report corresponds to the target second-hand vehicle;

calling a target usage smart contract corresponding to the target vehicle condition evaluation report, and initiating a vehicle condition evaluation report transaction request to the buyer client;

sending the target vehicle condition evaluation report to the buyer client after the transaction confirmation of the buyer client is received, and sharing the income of the vehicle condition evaluation report transaction according to the income sharing rule.

Optionally, the sales smart contract further comprises a sales income sharing rule, wherein said performing a target sales smart contract according to a target second-hand vehicle information selected by the buyer client particularly comprises:

calling the target sales smart contract corresponding to the target second-hand vehicle according to the target second-hand vehicle information selected by the buyer client, and initiating a second-hand vehicle transaction request to the buyer client;

sending vehicle ownership transfer information of the target second-hand vehicle to the buyer client, and sharing sales income according to the sales income sharing rule after the transaction confirmation of the buyer client is received.

The second aspect of the embodiments of the present application provides a server comprising:

a memory which stores an executable computer program;

a processor coupled to the memory, by calling the executable computer program in the memory, the processor is configured to:

receive second-hand vehicle sales information and a sales smart contract submitted by a seller client, wherein the sales smart contract comprises a second-hand vehicle sales price;

register the second-hand vehicle sales information and the sales smart contract in a block chain and radioing the second-hand vehicle sales information and the sales smart contract in the entire network of the block chain;

receive a second-hand vehicle transaction request submitted by a buyer client;

search matched second-hand vehicle sales information according to the second-hand vehicle transaction request and sending the matched second-hand vehicle sales information to the buyer client;

execute a target sales smart contract according to a target second-hand vehicle information selected by the buyer client; and

generate a second-hand vehicle sales contract according to an execution result of the target sales smart contract, and register the second-hand vehicle sales contract into the block chain after the second-hand vehicle sales contract is confirmed by the buyer client and the seller client.

Optionally, before said receiving second-hand vehicle sales information and a sales smart contract submitted by a seller client, by calling the executable computer program in the memory, the processor is further configured to:

receive the second-hand vehicle evaluation request submitted by the seller client, wherein the second-hand vehicle evaluation request comprises a vehicle identifier and a usage authorization of historical vehicle condition information;

verify the validity of the second-hand vehicle evaluation request;

call the historical vehicle condition information corresponding to the vehicle identifier, and generate a vehicle condition evaluation report and a second-hand vehicle recommended sales price based on the usage authorization of historical vehicle condition information, if the second-hand vehicle evaluation request is valid; and

send the vehicle condition evaluation report and the second-hand vehicle recommended sales price to the seller client, so as to make a reference for the seller client when the second-hand vehicle sales information and the sales smart contract are submitted by the seller client.

Optionally, after said generating a vehicle condition evaluation report and a second-hand vehicle recommended sales price, by calling the executable computer program in the memory, the processor is further configured to:

generate a usage smart contract of the vehicle condition evaluation report, wherein the usage smart contract comprises a usage charging rule of the vehicle condition evaluation report, and an income sharing rule;

send the usage smart contract to the seller client; and

register the vehicle condition evaluation report and the usage smart contract into the block chain and radio the vehicle condition evaluation report and the usage smart contract in the whole network after a confirmation instruction of the seller client is received.

Optionally, before said performing a target sales smart contract according to target second-hand vehicle information selected by the buyer client, by calling the executable computer program in the memory, the processor is further configured to:

receive a target vehicle condition evaluation report review request sent by the buyer client, wherein the target vehicle condition evaluation report corresponds to the target second-hand vehicle;

call a target usage smart contract corresponding to the target vehicle condition evaluation report, and initiate a vehicle condition evaluation report transaction request to the buyer client;

send the target vehicle condition evaluation report to the buyer client after the transaction confirmation of the buyer client is received, and share the income of the vehicle condition evaluation report transaction according to the income sharing rule.

Optionally, the sales smart contract further comprises a sales income sharing rule, and correspondingly, by calling the executable computer program in the memory, the processor is particularly configured to:

call the target sales smart contract corresponding to the target second-hand vehicle and initiating a second-hand vehicle transaction request to the buyer client according to the target second-hand vehicle information selected by the buyer client;

send the vehicle ownership transfer information of the target second-hand vehicle to the buyer client after the transaction confirmation of the buyer client is received, and share sales income according to the sales income sharing rule.

In the embodiment of the present application, by utilizing the characteristic that the data in the block chain having characteristics of decentralization and tamper resistance, after the server receives the second-hand vehicle sales information and the sales smart contract submitted by the seller client which are registered in the block chain and are radio in the whole network; and after the second-hand vehicle transaction request submitted by the buyer client is received, the matched second-hand vehicle sales information is searched according to the request and the matched second-hand vehicle sales information is sent to the buyer client; if the buyer client selects the target second-hand vehicle, the target sales smart contract is executed, such that the second-hand vehicle sales contract is generated, and is registered in the block chain after it is confirmed by the buyer client and the seller client. In this process, the server registers the sales information of the second-hand vehicle seller and the information of purchasing the second-hand vehicle from the second-hand buyer in the block chain thereby guaranteeing safety and tamper resistance of the transaction data of the second-hand vehicle, and guaranteeing the safety of the transaction data and the transparency of the transaction.

### BRIEF DESCRIPTION OF THE DRAWINGS

In order to illustrate the technical solutions provided by the embodiments of the present application more clearly, the drawings required to be used in the embodiments are introduced briefly hereinafter.

FIG. 1 is a structural schematic diagram of a second-hand vehicle transaction system according to an embodiment of the present application;

FIG. 2 is a flow schematic diagram of a second-hand vehicle transaction method according to an embodiment of the present application; and

FIG. 3 is a structural schematic diagram of a server according to an embodiment of the present application.

### DETAILED DESCRIPTION OF THE ENABLING EMBODIMENTS

In order to enable technical problems, technical solutions, and technical advantages of the present application to be clearer and more understandable, the present application will be further described in detail hereinafter with reference to the drawings and embodiments. In the description of the application, the terms of “first” and “second” are used only for purposes of distinguishing description, but shouldn't be interpreted as indicating or implying the relative importance. In other cases, detailed description of well-known systems, systems, circuits and methods are omitted so as not to obscure the description of the present application with unnecessary detail.

In order to explain the technical solutions described in the present application, specific embodiments are used to illustrate the technical solutions hereinafter.

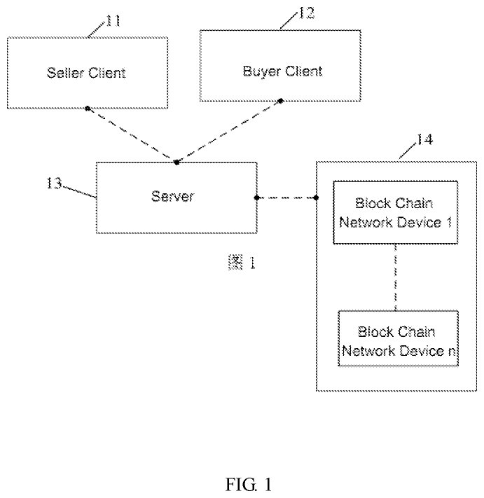

FIG. 1 is a structural schematic diagram of a second-hand vehicle transaction system provided by an embodiment of the present application, the second-hand vehicle transaction system comprises a seller client 11, a buyer client 12, a server 13 and a plurality of block chain network devices 14 serving as block chain nodes, and the seller client 11, the buyer client 12 and the block chain network devices 14 are respectively connected with the server 13. The buyer client 12 is configured to send second-hand vehicle sales information and a sales smart contract to the server 13, the seller client 11 is configured to send a second-hand vehicle transaction request to the server, the server 13 is configured to register the received second-hand vehicle sales information and the sales smart contract in the block chain network devices 14 and radio the received second-hand vehicle sales information and the sales smart contract in the entire network of the block chain, and the server is further configured to search for a proper second-hand vehicle according to the second-hand vehicle transaction request of the buyer client 12, so that after the buyer client confirms that the buyer needs to purchase a vehicle, a second-hand vehicle sales contract is signed. The block chain network devices 14 are configured to receive related data sent by the server 13 and store the related data. Further, the seller client 11 and the buyer client 12 may be one of intelligent terminals, such as a personal computer, a smart phone, a tablet computer, an intelligent wearable device or the like. The server 13 may send information to the block chain network devices 14 and the block chain network devices 14 registers the information in the block chain and radios the information in the entire network of the block chain and the server 13 can also be registered in the block chain and become a node device of the block chain.

### Embodiment 1

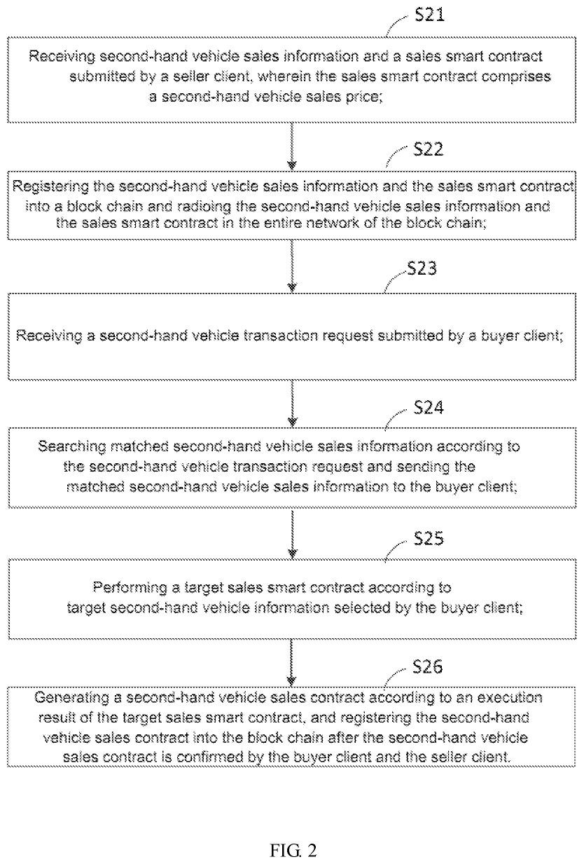

FIG. 2 shows a flow schematic diagram of a second-hand vehicle transaction method according to another embodiment of the present application, the second-hand vehicle transaction method comprises step 21 to the step 26, and the detailed description is as follows:

Step 21: receiving second-hand vehicle sales information and a sales smart contract submitted by the seller client, wherein the sales smart contract comprises a second-hand vehicle sales price.

Step 22: registering the second-hand vehicle sales information and the sales smart contract into a block chain and radioing the second-hand vehicle sales information and the sales smart contract in the entire network of the block chain.

Step 23: receiving a second-hand vehicle transaction request submitted by the buyer client.

Step 24: searching matched second-hand vehicle sales information according to the second-hand vehicle transaction request and sending the matched second-hand vehicle sales information to the buyer client.

Step 25: performing a target sales smart contract according to target second-hand vehicle information selected by the buyer client.

Step 26: generating a second-hand vehicle sales contract according to an execution result of the target sales smart contract, and registering the second-hand vehicle sales contract into the block chain after the second-hand vehicle sales contract is confirmed by the buyer client and the seller client.

According to the embodiment of the present application, the server firstly receives the second-hand vehicle sales information sent by the seller client of the second-hand vehicle and the sales smart contract, the second-hand vehicle sales information comprises basic information such as the second-hand vehicle type, the second-hand vehicle style, the emissions, the color and the like, and further comprises the information of the vehicle to be sold, such as the license plate number, the age of the vehicle and the operation condition of the engine, the running state of the safety device and the electronic equipment, the driving mileage and the like. The sales price of the second-hand vehicle is included in the sales smart contract. The server sends the received second-hand vehicle sales information and the sales smart contract to a block chain network for storage, and full-network radioing is carried out, that is, radioing is carried out in the block chain network, so that other block chain node devices can also obtain the same information, and the other block chain node devices is indicated to store the received information. Optionally, when the server sends the second-hand vehicle sales information and the sales smart contract to the block chain network, the second-hand vehicle sales information and the sales smart contract can be packaged and then sent after being packaged.

The server waits for receiving the second-hand vehicle transaction request submitted by the buyer client, that is, the buyer client waits for a user who needs to purchase the second-hand vehicle to send a purchase request of the second-hand vehicle, when the buyer client receives the second-hand vehicle transaction request, the second-hand vehicle transaction request is sent to the server. The transaction request contains the model and style of the second-hand vehicle to be purchased by the buyer and the price interval of the shopping cart, and therefore, the server receives the second-hand vehicle transaction request, and the second-hand vehicle sales information conforming to various conditions in the transaction request can be found according to the information in the transaction request, and then the found second-hand vehicle sales information is sent to the buyer client. The second-hand vehicle sales information can be information of one second-hand vehicle or information of a plurality of second-hand vehicles. After receiving the second-hand vehicle transaction information, the buyer client displays the second-hand vehicle transaction information to the corresponding buyer, so that the buyer can select the target second-hand vehicle which the user wants to purchase. At this time, the server waits for receiving confirmation information from the buyer client for purchasing the target second-hand vehicle, and then the sales smart contract corresponding to the sales information of the target second-hand vehicle is executed according to the target second-hand vehicle information selected by the buyer, so as to generate a sell contract of the target second-hand vehicle, the server sends the sell contract of the target second-hand vehicle to the buyer client and the seller client to instruct the two clients to confirm the order of the second-hand vehicle, and if both parties agree on the content specified by the sell contract of the target second-hand vehicle, and if the sell contract is determined to be established, the transaction activity of the target second-hand vehicle is completed, and the server is configured to register the sell contract of the target second-hand vehicle in the block chain network.

It should be noted that the data is stored in a block chain network in a block form. Each block comprises two parts, a block header and a block body, wherein the block header is configured to record the characteristic values of the current block, the block body is the actual data. The block header includes a plurality of feature values for the current block. The feature values include a generation time, a hash value of the block body and a hash value of the previous block. The hash value of the block is calculated for the block header. In other words, various characteristic values of the block header are sequentially connected together to form a very long character string, and then a hash value is calculated for the character string, so that the hash value of each block is different, and the hash value of each block can be obtained through the hash identification block.

Due to the fact that the block header contains many contents, wherein the hash of the current block body is carried out, and the hash of the previous block body is carried out. Due to the consensus mechanism of the block chain, it is almost impossible to modify a plurality of blocks within a short time, and the calculation capability of more than 51% of the whole network is mastered by someone. Thus, the characteristics of decentralization and tamper resistance of the block chain are formed.

Therefore, in the embodiment of the present application, utilizing the data in the block chain having the characteristics of decentralization and tamper resistance, according to that the sales information of the second-hand vehicle, the information of the sales smart contract, the sales contract and the like are all registered in the block chain network, it is guaranteed that the acquired vehicle condition data is the original data which is not tampered with real and reliability of the data is ensured.

In addition, the sales smart contract is a section of computer execution program capable of automatically executing contract terms. According to the method, a smart contract is not generated, and a smart contract cannot be modified; the method has the advantages that a set of complex and the digital commitment with the trigger condition can be executed correctly according to the intention of the participant. Therefore, after the smart contract is deployed on the block chain, namely waiting for being called, the smart contract cannot be changed.

More smart contract are generally deployed on the block chain, and the smart contract is provided with an identifier for identify the smart contract, such as a sales type smart contract. Optionally, the identifier of the smart contract can be the name of the smart contract, and is configured to uniquely identify the smart contract deployed on the block chain. Therefore, the information sent by the user terminal to the block chain can carry identifiers of different smart contracts, so that after the node devices in the block chain network receives relevant data carrying the smart contract identifier information, the corresponding program can be executed by calling the corresponding smart contract.

Optionally, in another embodiment provided by the present application, the method further comprises the following steps: before the second-hand vehicle sales information and the sales smart contract submitted by the seller client being received, the method further comprises:

The second-hand vehicle evaluation request submitted by the seller client is received, wherein the second-hand vehicle evaluation request comprises a vehicle identifier and usage authorization of historical vehicle condition information.

The validity of the second-hand vehicle evaluation request is verified.

If the second-hand vehicle evaluation request is valid, historical vehicle condition information corresponding to the vehicle identifier is called based on the usage authorization of historical vehicle condition information, and generating a vehicle condition evaluation report and a second-hand vehicle recommended sales price.

The vehicle condition evaluation report and the second-hand vehicle recommended sales price are sent to a seller client, so as to be reference for the seller client to submit the second-hand vehicle sales information and the sales smart contract.

In the embodiment, the server is configured to evaluate the vehicle condition of the second-hand vehicle according to the second-hand vehicle evaluation request of the seller client, wherein the evaluation request comprises information such as the vehicle identifier of the second-hand vehicle, the usage authorization of the historical vehicle condition information and the like. Specifically, the server verifies whether the second-hand vehicle evaluation request contains vehicle ownership certification, and whether the vehicle identifier in the ownership certificate is consistent with the identification in the second-hand vehicle evaluation request, so as to determine whether the evaluation request of the second-hand vehicle is valid or not. The vehicle ownership certification can be a vehicle driving certificate of the second-hand vehicle, and the vehicle identifier can be the license plate number of the second-hand vehicle. The vehicle driving certificate is generally recorded with information such as the owner of the vehicle, the license plate number and the like, and in practical application, the vehicle is only provided with only one license plate number, so that whether the second-hand vehicle evaluation requests are valid or not can be determined according to the vehicle driving certificate. For example, the vehicle owner A in the second-hand vehicle evaluation request sent by the seller client is A, and the license plate number is aaa, if the vehicle owner recorded on the vehicle driving certificate is also A, and the license plate number is aaa, it is judged that the second-hand vehicle evaluation request is valid.

If the second-hand vehicle evaluation requests are valid, the historical vehicle condition information corresponding to the vehicle identifier of the second-hand vehicle is called according to the usage authorization of historical vehicle condition information, so as to evaluate the vehicle condition carried out by the second-hand vehicle according to the historical vehicle condition information, the recommended sales price of the second-hand vehicle is given, and then an evaluation report is generated according to the evaluation result. For example, divided second-hand vehicle into different driving grades based on different driving history in advance, and the called historical driving information of the second-hand vehicle is matched with the preset driving grade of the second-hand vehicle, so as to determine the driving grade of the second-hand vehicle. In addition, it should be noted that the second-hand vehicle recommended sales prices are the second-hand vehicle sales price reference.

Optionally, in another embodiment provided in the present application, after the vehicle condition evaluation report and the two-hand recommended sales price are generated, the method further comprises the following steps:

A usage smart contract of the vehicle condition evaluation report is generated, wherein the usage smart contract comprises a usage charging rule of the vehicle condition evaluation report, and an income sharing rule.

The usage smart contract is sent to the seller client.

After the confirmation instruction of the seller client is received, and the vehicle condition evaluation report and the usage smart contract are registered in a block chain and are radioed in the entire network of the block chain.

In this embodiment, after the vehicle condition evaluation report of the second-hand vehicle is generated, generating a usage smart contract according to the record information in the evaluation report, the usage smart contract is configured to specify the fee required to be paid when the user needs to use or check the evaluation report, and the sharing rule of income from usage of the evaluation report, the income from usage of the evaluation report are mainly distributed to the seller of the second-hand vehicle and the operator of the second-hand vehicle service platform where the server with the evaluation report is located. The usage smart contract is sent to a seller client, and the second-hand vehicle seller checks the usage smart contract through the seller client, and if it is agreed that the relevant regulations in the usage smart contract are used, and a confirmation instruction is sent to the server through the seller client, the server receives the confirmation instruction, and the vehicle condition evaluation report and the usage smart contract are registered in the block chain and are radioed in the entire network of the block chain. Further, before being sent to the block chain network, the vehicle condition evaluation report is encrypted by the server so it can be sent to and registered in the block chain network in an encrypted form. The usage smart contracts are registered in a block chain in an unencrypted form, when user needs to check or use the vehicle condition evaluation report, the method comprises the following steps: firstly, judging whether it meets the conditions specified in the above-mentioned usage smart contract, if yes, sending the decrypted vehicle condition evaluation report to the user; otherwise, the user is refused to use or check the vehicle condition evaluation report.

Optionally, in another embodiment provided in the present application, before the target sales smart contract is executed according to the target second-hand vehicle information selected by the buyer client, the method further comprises:

A target vehicle condition evaluation report review request sent by a buyer client is received, wherein the target vehicle condition evaluation report corresponds to the target second-hand vehicle.

A target usage smart contract corresponding to the target vehicle condition evaluation report is called and a vehicle condition evaluation report transaction request is sent to the buyer client.

After the transaction confirmation of the buyer client is received, the target vehicle condition evaluation report is sent to the buyer client, and the income of the vehicle condition evaluation report transaction is shared according to the income sharing rule.

In this embodiment, the server receives a review request of a target vehicle condition evaluation report sent by a buyer client, and the target vehicle condition evaluation report is the vehicle condition evaluation report of the target second-hand vehicle; for example, the buyer B sends a vehicle condition evaluation report review request for the target second-hand vehicle C through the buyer client M, the server calls the usage smart contract D corresponding to the target second-hand vehicle C, and initiating a vehicle condition evaluation report transaction request to the buyer client M according to the usage smart contract D, and waiting for the buyer client M to feed back the vehicle condition evaluation report transaction request, and if the server receives the feedback of the buyer client M for the vehicle condition evaluation report transaction request, the vehicle condition evaluation report of the target second-hand vehicle C is sent to the buyer client M, and the income of the vehicle condition evaluation report transaction is shared according to the income sharing rule. The income sharing rule is stored in the usage smart contract of the target second-hand vehicle C, for example, 40% of the income of the vehicle condition evaluation report transaction is shared to the seller of the second-hand vehicle, 60% is distributed to the operator of the second-hand vehicle service platform where the server is located.

Optionally, in another embodiment provided in the present application, the sales smart contract further comprises sales income sharing rule, and the target sales smart contract is executed according to the target second-hand vehicle information selected by the buyer client the method specifically comprises the following steps:

According to the target second-hand vehicle information selected by the buyer client, a target sales smart contract corresponding to the target second-hand vehicle is called to initiate a second-hand vehicle transaction request to the buyer client.

After the transaction confirmation of the buyer client is received, the vehicle ownership transfer information of the target second-hand vehicle is sent to the buyer client and the sales income are divided into rules according to the sales income.

In the embodiments of the present application, if the second-hand vehicle buyer H determines that the second-hand vehicle I needs to be purchased (such as the purchase request sent to the server by the second-hand vehicle buyer H through the buyer client J), and the server calls the target sales smart contract K of the target second-hand vehicle I, and sends a second-hand vehicle transaction request to the buyer client J according to the target sales smart contract K, and waits for the feedback information sent by the buyer client J. The server sends the vehicle ownership transfer information of the target second-hand vehicle I to the buyer client J if the server receives the confirmation information of the buyer client J, and the sales income from the second-hand vehicle transaction is shared based on the sales income sharing rule. The vehicle ownership transfer information includes contacts of physical handover of the second-hand vehicle, location information and corresponding handover procedures, such as transfer registration and the like in the traffic management or vehicle management depal ftnent. For example, a contact person responsible for carrying out handover between a buyer and a seller of the target second-hand vehicle I, the time and the place of the target second-hand vehicle I and related procedures needing to be handled in the handover process, and the like. The benefits of the sales income are as follows: a seller of the second-hand vehicle and the operator of second-hand vehicle service platform where the server is located, and the like, and the seller of the second-hand vehicle receives the car cash of the second-hand vehicle, the operator of the second-hand vehicle service platform where the server is located receives the service cost of the second-hand vehicle transaction service.

In the embodiment of the present application, the data in the block chain are utilized to have the characteristics of decentralization and tamper resistance, the server receives the second-hand vehicle sales information submitted by the seller client and the sales smart contract, and the data are registered in the block chain and are radioed in the entire network of the block chain; and after the second-hand vehicle transaction request submitted by the buyer client is received, the matched second-hand vehicle sales information is found according to the request and sent to the buyer client; if the buyer client selects the target second-hand vehicle, the target sales smart contract is executed to generate the second-hand vehicle sales contract, and registering in the block chain after the confirmation of the buyer client and the seller client is obtained. In the process, the server registers the sales information of the second-hand vehicle seller and the information of purchasing the second-hand vehicle from the second-hand buyer into the block chain, the safety of the transaction data of the second-hand vehicle is guaranteed, and the safety of the transaction data and the transparency of the transaction are guaranteed.

### Embodiment 2

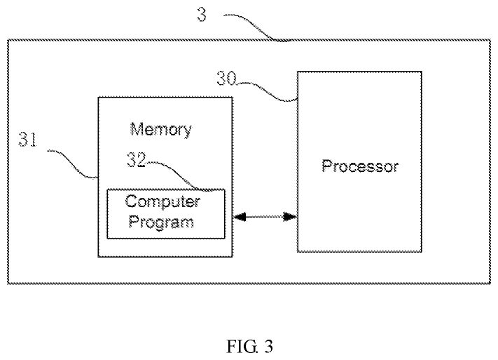

FIG. 3 is a structural schematic diagram of the server 3 according to an embodiment of the present application. The server 3 of the embodiment comprises a processor 30, a memory 31, and a computer program 32 stored in the memory 31 and capable of running in the processor 30, for example, a program in the second-hand vehicle transaction method. The processor 30 implements the steps in the embodiments of the vehicle evaluation method mentioned above when executing the computer program 32, such as step 21 to step 26 shown in FIG. 2, the processor 30 executes the computer program 42 to implement the step 21 to 26 shown in FIG. 2.

The server 3 may include, but is not limited to, a processor 30 and a memory 31. It can be understood by those skilled in the art that FIG. 3 is only an example of the server 3 and does not constitute a limitation to the server 3, more or fewer components may be included, or some components may be combined, or different components may be combined, such as an input/output device, a network access device, a bus and the like.

The processor 30 may be a central processing unit (CPU), and can also be other general-purpose processors, digital signal processors (DSP), an application specific integrated circuit (ASIC), a field-programmable gate array (FPGA) or other programmable logic devices, discrete gate or transistor logic devices, discrete hardware components and the like. The general-purpose processor may be a microprocessor or the processor may be any conventional processor or the like.

The memory 31 may be an internal storage unit of the server 3, such as a hard disk or a memory of the server 3. The memory 31 may also be an external storage device of the server 3, for example, a plug-in type hard disk arranged on the server 3, a smart media card (SMC), a secure digital (SD) a flash card and the like. Further, the memory 31 may also include both an internal storage unit of the server 3 and an external storage device. The memory 31 is configured to store the computer program and other programs and data needed by the insurance. The memory 31 may also be used to temporarily store data that has been output or to be output.

When the server 3 is carrying out the second-hand vehicle transaction, the processor 30 executes the computer program 42 stored in the memory 31.

The second-hand vehicle sales information and the sales smart contract submitted by the seller client is received, the sales smart contract comprises a second-hand vehicle sales price.

The second-hand vehicle sales information and the sales smart contract are registered in a block chain and radioed in the entire network of the block chain;

The second-hand vehicle transaction request submitted by the buyer client is received.

According to the second-hand vehicle transaction request, matched second-hand vehicle sales information is searched and sent to a buyer client.

According to the target second-hand vehicle information selected by the buyer client, the target sales smart contract is executed.

According to the execution result of the target sales smart contract, a second-hand vehicle sales contract is generated, and registering it in the block chain after the second-hand vehicle sales contract is confirmed by the buyer client and the seller client.

Optionally, before the second-hand vehicle sales information and the sales smart contract submitted by the seller client is received, the processor calls executable computer programs in the memory and is further used for:

The second-hand vehicle evaluation request submitted by the seller client is received, wherein the second-hand vehicle evaluation request comprises a vehicle identifier and usage authorization of historical vehicle condition information.

The validity of the second-hand vehicle evaluation request is verified.

If the second-hand vehicle evaluation request is valid, the historical vehicle condition information corresponding to the vehicle identifier is called, and a vehicle condition evaluation report and a second-hand vehicle recommended sales price generated based on the usage authorization of the historical vehicle condition information.

The vehicle condition evaluation report and the second-hand vehicle recommended sales price are sent to the seller client, so as to make a reference for the seller client when the second-hand vehicle sales information and the sales smart contract are submitted by the seller client timely.

Optionally, after the processor generates a vehicle condition evaluation report and a second-hand vehicle suggests sales price, the processor calls executable computer programs in the memory and is further used for:

A usage smart contract of the vehicle condition evaluation report is generated, wherein the usage smart contract comprises a usage charging rule of the vehicle condition evaluation report, and an income sharing rule; the usage smart contract are sent to the seller client.

After a confirmation instruction of the seller client is received, the vehicle condition evaluation report and the usage smart contract are registered in the block chain and radioed in the entire network of the block chain.

Optionally, before the performing a target sales smart contract according to target second-hand vehicle information selected by the buyer client, the processor calls executable computer programs in the memory and is further used.

A target vehicle condition evaluation report review request sent by a buyer client is received, wherein the target vehicle condition evaluation report corresponds to the target second-hand vehicle.

A target usage smart contract corresponding to the target vehicle condition evaluation report is called, and a vehicle condition evaluation report transaction request to the buyer client is initiated.

After the transaction confirmation of the buyer client is received, the target vehicle condition evaluation report is sent to the buyer client, and the income of the vehicle condition evaluation report transaction are sharing according to the income sharing rule.

Optionally, the sales smart contract further includes a sales income sharing rule, and correspondingly, the processor calls executable computer programs in the memory, which is specifically used for:

According to the target second-hand vehicle information selected by the buyer client, a target sales smart contract corresponding to the target second-hand vehicle is called to initiate a second-hand vehicle transaction request to the buyer client.

After the transaction confirmation of the buyer client is received, send the vehicle ownership transfer information of the target second-hand vehicle to the buyer client and share the sales income according to the sales income sharing rule.

The computer program 32 may be partitioned into one or more units/modules, the one or more units/modules are stored in the memory 31, and are executed by the processor 30 so as to complete the application.

The server 3 can be a cloud server, an intelligent device, a computer, a notebook computer, a hand-held computer and other computing devices. The server 3 may include, but is not limited to, a processor 30, the memory 31 can be understood by those skilled in the art, and FIG. 3 is only an example of the server 3, which is not limited to the server 3, may include more or fewer components than shown, or combine certain components, or different components, for example, the server 3 can further comprise input/output equipment, network access equipment, a bus and the like.

Those skilled in the art can clearly understand that the method is convenient and concise for description, and the specific working procedures described above can be referred to the corresponding processes in the preceding method embodiments, and are not described in detail herein.

In several embodiments provided herein, it should be appreciated that, the system, the server and the method disclosed by the present application can be realized in other manners. The units illustrated as separate components may or may not be physically separate, the component displayed as a unit can be or may not be a physical element. According to actual requirements, some or all of the units can be selected to achieve the purpose of the scheme of the embodiment.

If the function is implemented in the form of a software functional unit and sold or used as an independent product, it can be stored in a computer readable storage medium. Based on such understanding, the technical solutions of the present application are essentially, or the part contributing to the prior art or part of the technical solution, can be embodied in the form of a software product. The computer software product is stored in a storage medium, wherein instructions are included and used for enabling a computer device (which can be a personal computer, a server, a network device or the like) to implement a whole or part of the steps of the method disclosed by the embodiment of the present application. The storage medium comprises a medium storing program codes, such as a USB flash disk, a removable hard disk, a read-only memory (ROM), a random access memory (RAM), a magnetic disk, an optical disk or the like.

The above descriptions are only preferred embodiments of the present application, and are not intended to limit the present application. Any modification, equivalent replacement, improvement and the like, which are made within the spirit and principle of the present application, should all be included in the protection scope of the present application.

1. A second-hand vehicle transaction method comprising:
receiving second-hand vehicle sales information and a sales smart contract submitted by a seller client, wherein the sales smart contract comprises a second-hand vehicle sales price;
registering the second-hand vehicle sales information and the sales smart contract into a block chain and radioing the second-hand vehicle sales information and the sales smart contract in the entire network of the block chain;
receiving a second-hand vehicle transaction request submitted by a buyer client;
searching matched second-hand vehicle sales information according to the second-hand vehicle transaction request and sending the matched second-hand vehicle sales information to the buyer client;
performing a target sales smart contract according to target second-hand vehicle information selected by the buyer client;
generating a second-hand vehicle sales contract according to an execution result of the target sales smart contract, and registering the second-hand vehicle sales contract into the block chain after the second-hand vehicle sales contract is confirmed by the buyer client and the seller client.

2. The method as claimed in claim 1, wherein before said receiving second-hand vehicle sales information and a sales smart contract submitted by a seller client, the method further comprises:
receiving a second-hand vehicle evaluation request submitted by the seller client, wherein the second-hand vehicle evaluation request comprises a vehicle identifier and usage authorization of historical vehicle condition information;
verifying the validity of the second-hand vehicle evaluation request;
if the second-hand vehicle evaluation request is valid, calling the historical vehicle condition information corresponding to the vehicle identifier based on the usage authorization of historical vehicle condition information, and generating a vehicle condition evaluation report and a second-hand vehicle recommended sales price; and
sending the vehicle condition evaluation report and the second-hand vehicle recommended sales price to the seller client, to make a reference for the seller client when the second-hand vehicle sales information and the sales smart contract are submitted by the seller client.

3. The method as claimed in claim 2, wherein after said generating a vehicle condition evaluation report and a second-hand vehicle recommended sales price, the method further comprises:
generating a usage smart contract of the vehicle condition evaluation report, wherein the usage smart contract comprises a usage charging rule of the vehicle condition evaluation report, and an income sharing rule;
sending the usage smart contract to the seller client;
registering the vehicle condition evaluation report and the usage smart contract into the block chain and radioing the vehicle condition evaluation report and the usage smart contract after a confirmation instruction from the seller client is received.

4. The method as claimed in claim 3, wherein before said performing a target sales smart contract according to target second-hand vehicle information selected by the buyer client, the method further comprises:
receiving a target vehicle condition evaluation report review request sent by the buyer client, wherein the target vehicle condition evaluation report corresponds to the target second-hand vehicle;
calling a target usage smart contract corresponding to the target vehicle condition evaluation report, and initiating a vehicle condition evaluation report transaction request to the buyer client;
sending the target vehicle condition evaluation report to the buyer client after the transaction confirmation of the buyer client is received, and sharing the income of the vehicle condition evaluation report transaction according to the income sharing rule.

5. The method as claimed in claim 1, wherein the sales smart contract further comprises a sales income sharing rule, wherein said performing a target sales smart contract according to a target second-hand vehicle information selected by the buyer client particularly comprises:
calling the target sales smart contract corresponding to the target second-hand vehicle according to the target second-hand vehicle information selected by the buyer client, and initiating a second-hand vehicle transaction request to the buyer client;
sending vehicle ownership transfer information of the target second-hand vehicle to the buyer client, and sharing sales income according to the sales income sharing rule after the transaction confirmation of the buyer client is received.

6. A server comprising:
a memory which stores an executable computer program;
a processor coupled to the memory, by calling the executable computer program in the memory, the processor is configured to:
receive second-hand vehicle sales information and a sales smart contract submitted by a seller client, wherein the sales smart contract comprises a second-hand vehicle sales price;
register the second-hand vehicle sales information and the sales smart contract in a block chain and radioing the second-hand vehicle sales information and the sales smart contract in the entire network of the block chain;
receive a second-hand vehicle transaction request submitted by a buyer client;
search matched second-hand vehicle sales information according to the second-hand vehicle transaction request and sending the matched second-hand vehicle sales information to the buyer client;
execute a target sales smart contract according to a target second-hand vehicle information selected by the buyer client; and
generate a second-hand vehicle sales contract according to an execution result of the target sales smart contract, and register the second-hand vehicle sales contract into the block chain after the second-hand vehicle sales contract is confirmed by the buyer client and the seller client.

7. The server as claimed in claim 6, wherein before said receiving second-hand vehicle sales information and a sales smart contract submitted by a seller client, by calling the executable computer program in the memory, the processor is further configured to:
receive the second-hand vehicle evaluation request submitted by the seller client, wherein the second-hand vehicle evaluation request comprises a vehicle identifier and a usage authorization of historical vehicle condition information;
verify the validity of the second-hand vehicle evaluation request;
call the historical vehicle condition information corresponding to the vehicle identifier, and generate a vehicle condition evaluation report and a second-hand vehicle recommended sales price based on the usage authorization of historical vehicle condition information, if the second-hand vehicle evaluation request is valid; and
send the vehicle condition evaluation report and the second-hand vehicle recommended sales price to the seller client, so as to make a reference for the seller client when the second-hand vehicle sales information and the sales smart contract are submitted by the seller client.

8. The server as claimed in claim 7, after said generating a vehicle condition evaluation report and a second-hand vehicle recommended sales price, by calling the executable computer program in the memory, the processor is further configured to:
generate a usage smart contract of the vehicle condition evaluation report, wherein the usage smart contract comprises a usage charging rule of the vehicle condition evaluation report, and a income sharing rule;
send the usage smart contract to the seller client; and
register the vehicle condition evaluation report and the usage smart contract into the block chain and radio the vehicle condition evaluation report and the usage smart contract in the whole network after a confirmation instruction of the seller client is received.

9. The server as claimed in claim 8, wherein before said performing a target sales smart contract according to target second-hand vehicle information selected by the buyer client, by calling the executable computer program in the memory, the processor is further configured to:
receive a target vehicle condition evaluation report review request sent by the buyer client, wherein the target vehicle condition evaluation report corresponds to the target second-hand vehicle;
call a target usage smart contract corresponding to the target vehicle condition evaluation report, and initiate a vehicle condition evaluation report transaction request to the buyer client;
send the target vehicle condition evaluation report to the buyer client after the transaction confirmation of the buyer client is received, and share the income of the vehicle condition evaluation report transaction according to the income sharing rule.

10. The server as claimed in claim 6, wherein
the sales smart contract further comprises a sales income sharing rule, and correspondingly, by calling the executable computer program in the memory, the processor is particularly configured to:
call the target sales smart contract corresponding to the target second-hand vehicle and initiating a second-hand vehicle transaction request to the buyer client according to the target second-hand vehicle information selected by the buyer client;
send the vehicle ownership transfer information of the target second-hand vehicle to the buyer client after the transaction confirmation of the buyer client is received, and share sales income according to the sales income sharing rule.

11. The method as claimed in claim 2, wherein the sales smart contract further comprises a sales income sharing rule, wherein said performing a target sales smart contract according to a target second-hand vehicle information selected by the buyer client particularly comprises:
calling the target sales smart contract corresponding to the target second-hand vehicle according to the target second-hand vehicle information selected by the buyer client, and initiating a second-hand vehicle transaction request to the buyer client;
sending vehicle ownership transfer information of the target second-hand vehicle to the buyer client, and sharing sales income according to the sales income sharing rule after the transaction confirmation of the buyer client is received.

12. The method as claimed in claim 3, wherein the sales smart contract further comprises a sales income sharing rule, wherein said performing a target sales smart contract according to a target second-hand vehicle information selected by the buyer client particularly comprises:
calling the target sales smart contract corresponding to the target second-hand vehicle according to the target second-hand vehicle information selected by the buyer client, and initiating a second-hand vehicle transaction request to the buyer client;
sending vehicle ownership transfer information of the target second-hand vehicle to the buyer client, and sharing sales income according to the sales income sharing rule after the transaction confirmation of the buyer client is received.

13. The method as claimed in claim 4, wherein the sales smart contract further comprises a sales income sharing rule, wherein said performing a target sales smart contract according to a target second-hand vehicle information selected by the buyer client particularly comprises:
calling the target sales smart contract corresponding to the target second-hand vehicle according to the target second-hand vehicle information selected by the buyer client, and initiating a second-hand vehicle transaction request to the buyer client;
sending vehicle ownership transfer information of the target second-hand vehicle to the buyer client, and sharing sales income according to the sales income sharing rule after the transaction confirmation of the buyer client is received.

14. The server as claimed in claim 7, wherein the sales smart contract further comprises a sales income sharing rule, and correspondingly, by calling the executable computer program in the memory, the processor is particularly configured to:
call the target sales smart contract corresponding to the target second-hand vehicle and initiating a second-hand vehicle transaction request to the buyer client according to the target second-hand vehicle information selected by the buyer client;
send the vehicle ownership transfer information of the target second-hand vehicle to the buyer client after the transaction confirmation of the buyer client is received, and share sales income according to the sales income sharing rule.

15. The server as claimed in claim 8, wherein the sales smart contract further comprises a sales income sharing rule, and correspondingly, by calling the executable computer program in the memory, the processor is particularly configured to:
call the target sales smart contract corresponding to the target second-hand vehicle and initiating a second-hand vehicle transaction request to the buyer client according to the target second-hand vehicle information selected by the buyer client;
send the vehicle ownership transfer information of the target second-hand vehicle to the buyer client after the transaction confirmation of the buyer client is received, and share sales income according to the sales income sharing rule.

16. The server as claimed in claim 9, wherein the sales smart contract further comprises a sales income sharing rule, and correspondingly, by calling the executable computer program in the memory, the processor is particularly configured to:
call the target sales smart contract corresponding to the target second-hand vehicle and initiating a second-hand vehicle transaction request to the buyer client according to the target second-hand vehicle information selected by the buyer client;
send the vehicle ownership transfer information of the target second-hand vehicle to the buyer client after the transaction confirmation of the buyer client is received, and share sales income according to the sales income sharing rule.
